(19) United States
(12) Patent Application Publication
(10) Pub. No.: US 2010/0296584 A1
(43) Pub. Date: Nov. 25, 2010

(54) METHOD AND DEVICE FOR ENCODING AND DECODING MULTIMEDIA DATA

(76) Inventors: Gero Bäse, Muenchen (DE); Thomas Rathgen, Ilmenau (DE)

Correspondence Address: STAAS & HALSEY LLP, SUITE 700, 1201 NEW YORK AVENUE, N.W., WASHINGTON, DC, 20005, US

(21) Appl. No.: 12/452,350

(22) PCT Filed: Jun. 6, 2008
(86) PCT No.: PCT/EP2008/057075

§ 371 Date: Mar. 2, 2010

(30) Foreign Application Priority Data
Jun. 27, 2007 (DE) 10 2007 029 599.7
Sep. 25, 2007 (DE) 10 2007 045 741.5

(51) Int. Cl. H04N 11/02

(52) U.S. Cl. 375/240.25; 375/240.01; 375/E07.026; 375/E07.027

(57) ABSTRACT

In a data aggregate formed of multimedia independent fragments, each of the fragments is assigned a respective explicit identifier for identifying that fragment. The identifier is stored in a respective metadata structure associated with the fragment. The metadata structure is used to store the identifiers for a first sequence, such as chronological order, and/or a second sequence, such as reverse chronological order.

### CROSS REFERENCE TO RELATED APPLICATIONS

This application is the U.S. national stage of International Application No. PCT/EP2008/057075, filed Jun. 6, 2008 and claims the benefit thereof. The International Application claims the benefits of German Application No. 10 2007 029 599.7 filed on Jun. 27, 2007 and German Application No. 10 2007 045 741.5 filed on Sep. 25, 2007, all applications are incorporated by reference herein in their entirety.

### BACKGROUND

Described below are a method and a device for encoding multimedia data and a method and a device for decoding multimedia data.

A large volume of multimedia data arises, for example, with video monitoring. For this, video and/or audio data, which is frequently continuous, is recorded by one of more cameras, and this is generally stored in numerous individual files. In order to make it easier to access selectively particular parts of the recorded data (e.g. time points or time periods), the files are limited in their sizes. For example, one file may contain video data with a length of between 5 and 15 minutes. However, limitation of the sizes of the individual files makes it necessary to administer numerous files if, for example, data is recorded for a period of 24 hours. This is generally effected by the systematic issuing of names for the individual files and/or by a hierarchical arrangement of the files over the time. The administration of these numerous individual files calls for a high expenditure of effort, making selective access to particular parts of the recorded files more difficult.

### SUMMARY

Described below is a method which makes it easier to administer numerous items of multimedia data and to selectively access individual parts of a complete set of data.

In the case of the method for encoding multimedia data described below, a data aggregate encompassing the multimedia data is formed from a number of mutually independent fragments. To each of this number of fragments is assigned an identifier, unique in each case, for the purpose of identifying the fragment concerned, where the identifier is stored in a metadata structure assigned to the fragment concerned. Stored in any particular metadata structure are the identifiers of a first fragment, in particular the chronologically preceding one, and/or of a second fragment, in particular the chronologically next-following (succeeding) one.

A device for encoding multimedia data is described below which incorporates a first facility for forming, from a number of mutually independent fragments, a data aggregate encompassing the multimedia data. The device incorporates in addition a second facility for generating and assigning to each of the number of fragments an identifier, unique in each case, to enable any particular fragment to be identified, where the identifier is stored in a metadata structure assigned to the fragment concerned. Finally, the device incorporates a third facility for storing in the relevant metadata structure the identifiers of a first fragment, in particular the chronologically preceding one, and/or of a second fragment, in particular the chronologically succeeding one.

In the case of the method described below for decoding multimedia data, which is stored in a data aggregate with a number of mutually independent fragments and is encoded in accordance with the inventive method, the identifiers of a first fragment, in particular the chronologically preceding one, and/or of a second fragment, in particular the chronologically succeeding one, contained in the metadata for a fragment of the data aggregate, are read out and processed in order to establish a connection, in particular a chronological one, between several of the fragments in the data aggregate.

Described below is a device for the decoding of multimedia data, which is stored in a data aggregate with a number of mutually independent fragments and is decoded in accordance with the method, incorporates a facility for reading out and processing the identifiers of the first fragment, in particular the chronologically preceding one, and/or of the second fragment, in particular the chronologically succeeding one, which are contained in the metadata of the data aggregate, in order to establish a connection, in particular a chronological one, between several of the fragments of the data aggregate.

Described below is a format for multimedia data which permits the data aggregate to be subdivided into individual fragments in a simple way. The format is suitable, in particular, for use in monitoring applications, in which large volumes of audio and/or video data arise. The provision of unique identifiers, each of which is assigned to one fragment, and the additional storage of the relevant identifiers for fragments, in particular a chronologically preceding one and a chronologically succeeding one, enables a connection to be established between the individual fragments. This makes it possible for the individual fragments to be read and used by standard software applications. In particular, it is possible to build up ring buffer structures for the efficient use of available storage space. At the same time, the effort for administering numerous mutually independent fragments is relieved, because the data items necessary for administration purposes are stored in the metadata structure of any particular fragment, and can be processed by the applications concerned.

In an expedient embodiment, time-related parameters for a fragment are provided in a relevant metadata structure of this fragment. The time-related parameters could be, for example, the start time and the duration of the fragment, i.e. the duration of the multimedia data stream contained in the fragment. The time-related parameters could also, for example, be in the form of a timestamp.

In a further expedient embodiment of the encoding method described below, parameters concerning the encoding of the multimedia data in a fragment are provided in a relevant metadata structure of this fragment. This data can be used for the application which is processing the data fragment, so that the multimedia data contained in the fragment can be prepared for output in an optimized way.

A further expedient embodiment provides that a relevant metadata structure of a fragment provides in the metadata structure concerned a link to a storage location for the first and/or the second fragment. In accordance with another form of embodiment this link can represent a URI (Uniform Resource Identifier) for the first and/or the second fragment. In this way, fragments can be linked to each other, because not only is the identifier, for the preceding or succeeding fragment as applicable, stored but the location of its storage is also saved in the link.

The number of fragments in the data aggregate can in principle be chosen arbitrarily, whereby the data aggregate could also encompass simply one single fragment. Accordingly, the number of fragments in the data aggregate is at least one.

It is further provided that the metadata structure for a fragment which has no chronological predecessor provides its own identifier as the identifier of the preceding fragment. Corresponding to this, provision is made that the metadata structure of the fragment which has no chronologically succeeding fragment provides its own identifier as the identifier of the succeeding fragment. In this way, the chosen encoding system can be adhered to if the data aggregate has only one single fragment. This applies equally for fragments which represent the first or last fragment respectively of the data aggregate.

As the identifier, a name and/or a timestamp and/or a UUID (Universally Unique Identifier) can be used. In principle, any characteristic which permits the unambiguous identification of a fragment concerned can be used as the identifier.

In a further expedient development of the encoding method described below, the identifiers are issued in a known succession, in particular in a sequence. By a systematic generation of the identifiers, the identification content of the relevant metadata structures can be further increased. In this way it is possible, for example, to recognize the number of fragments between two selected fragments. This is particularly easy if the identifiers are consecutive identifiers. This is equally possible if the sequence of the identifiers issued is known.

In this context, it is further expedient to generate fragments with the same length. In this case, all the fragments should have the same number of tracks and the same parameters for their timing and encoding settings. Correspondingly, provision can be made to generate fragments with the same encoding, in particular the same data rate and/or the same codecs. This embodiment enables the certainty of a correctly generated data aggregate to be increased because, for example, fragments which become lost can be detected.

The metadata structure assigned to a fragment can in principle be maintained and stored independently of the fragment. However, any particular metadata structure may be stored in its assigned fragment

In accordance with one embodiment of the method for decoding the multimedia data, each of the fragments of the data aggregate can be decoded and executed independently of other fragments in the data aggregate.

### BRIEF DESCRIPTION OF THE DRAWINGS

These and other aspects and advantages will become more apparent and more readily appreciated from the following description of the exemplary embodiments, taken in conjunction with the accompanying drawing of which:

The sole FIGURE is a schematic representation of a set of fragments FRn−1, FRn, FRn+1 of a data aggregate F.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Each of the three fragments FRn−1, FRn, FRn+1 shown by way of example incorporates multimedia data MM together with a metadata structure MDD. Each of the metadata structures MDD for any particular fragment FRn−1, FRn, FRn+1 includes an identifier ID, which permits unique identification of the fragment concerned. As the identifier ID, use may be made of a UUID (Universally Unique Identifier). Alternatively, the identifier could also be formed from a unique name and/or a timestamp, e.g. the time at which the fragment FRn−1, FRn, FRn+1 concerned was generated.

In addition, each metadata structure MDD for a particular fragment FRn−1, FRn, FRn+1 includes a number of attributes, which simplifies the administration of the several fragments FRn−1, FRn, FRn+1 and simplifies selective access to the relevant multimedia data MM for one or more of the fragments. As attributes for this purpose, the identifier of a first, chronologically preceding, fragment and the identifier of a second, chronologically succeeding, fragment are provided in the metadata structure MDD. The identifier of the chronologically preceding fragment is labeled as PreID, the identifier of the next-following (succeeding) fragment as SucID. The identifiers of the preceding and succeeding fragments PreID, SucID correspond in their type to the identifier ID of the fragment concerned.

In the exemplary embodiment illustrated in the FIGURE, the fragment FRn−1 is the fragment which precedes fragment FRn. Correspondingly, the identifiers in the attribute fields ID for FRn−1 and PreID for FRn agree with each other. The fragment which follows the fragment FRn is the fragment FRn+1. For this reason, the content of the identifier ID for FRn+1 agrees with the identifier in the SucID field of FRn. In the reverse way, the fragment FRn is the fragment which precedes the fragment FRn+1. Accordingly, the identifier ID of the fragment FRn is entered into the attribute field PreID of fragment FRn+1. Finally, the fragment FRn represents the fragment which follows the fragment FRn−1. Hence, the identifier ID of the fragment FRn is entered into the attribute field SucID of FRn−1.

As further attributes in any particular metadata structure MDD, it contains the start time ST and the duration D (e.g. in minutes), of the data stream contained in the multimedia data MM. From the FIGURE it can immediately be seen that the fragment FRn−1 has the value 11:55 as the start time ST and the duration D is 5. The start time ST of fragment FRn is 12:00, its duration D is 5. Corresponding to this, the start time ST of fragment FRn+1 is 12:05 and the duration D is 5. This example indicates that the fragments FRn−1, FRn, FRn+1 contain a continuous stream of multimedia data, containing data from 11:55 to 12:10.

It is expedient if, as in the exemplary embodiment shown, the durations D of each of the fragments are the same length. This notwithstanding, a variant is also possible in which the durations D of each of the fragments FRn−1, FRn, FRn+1 have different lengths.

Further to this, it is expedient if the fragments do not only have the same duration or length, as applicable, but if the multimedia data MM of any particular fragment is encoded in the same manner.

As a further parameter, any particular metadata structure MD can have a link to a storage location for the preceding or succeeding fragment, as applicable. However, this is not shown in the FIGURE for the exemplary embodiment. The link can be in the form, for example, of a URI (Uniform Resource Identifier).

The provision of any particular metadata structure in a fragment of a data aggregate F enables the individual fragments to be connected to each other, because from the metadata for any particular fragment it is possible at any time to find the succeeding fragment, so that a continuous output of the multimedia data stream contained in the fragments concerned is possible. In the present case, this functions in both directions (forwards and backwards). For the case when a fragment has no preceding and/or no succeeding fragment, this can be signaled by the relevant identifier of the attribute field referring to the fragment concerned itself.

The data content of the data or attributes, as applicable, contained in any particular metadata structure MDD can be increased in that the identifiers are generated systematically. For this purpose, the identifiers ID of the fragments FRn−1, FRn, FRn+1 can be issued in a known succession, in particular in a sequence. This makes it possible, for example, to recognize the number of fragments which lie between selected fragments. In this way it is possible in a simple way to determine whether individual fragments may have been lost.

Even though individual fragments are connected via the identifiers of preceding and succeeding fragments, contained in the metadata structures, the ability to decode and execute multimedia data contained in any particular fragments, independently of other fragments, continues to be assured.

The data format described permits the use of ring buffer structures for the efficient utilization of available storage space, whereby at the same time the effort for administration of the several fragments of the data aggregate is reduced.

The system also includes permanent or removable storage, such as magnetic and optical discs, RAM, ROM, etc. on which the process and data structures of the present invention can be stored and distributed. The processes can also be distributed via, for example, downloading over a network such as the Internet. The method can utilize a processor in a computer system to output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-18. (canceled)

19. A method for encoding multimedia data, comprising
forming a data aggregate encompassing multimedia data from fragments that are mutually independent;
assigning to each of the fragments a fragment identifier, unique in each case, identifying a corresponding fragment; and
storing, in a metadata structure assigned to the corresponding fragment, the fragment identifier and at least one of a preceding identifier of an immediately chronologically previous fragment and a succeeding identifier of an immediately chronologically following fragment.

20. The method as claimed in claim 19, further comprising storing time-related parameters for the corresponding fragment in the metadata structure of the corresponding fragment.

21. The method as claimed in claim 20, further comprising storing, in the metadata structure of each fragment, encoding parameters concerning how the multimedia data in the corresponding fragment is encoded.

22. The method as claimed in claim 21, further comprising storing, in the meta-data structure of each fragment, at least one link to a storage location for at least one of the immediately chronologically previous fragment and the immediately chronologically following fragment.

23. The method as claimed in claim 22, wherein the at least one link includes a uniform resource identifier for at least one of the immediately chronologically previous fragment and the immediately chronologically following fragment.

24. The method as claimed in claim 23, further comprising storing, in the metadata structure for an initial fragment which has no chronologically previous fragment, the fragment identifier as the preceding identifier.

25. The method as claimed in claim 24, further comprising storing, in the metadata structure for a final fragment which has no chronologically succeeding fragment, the fragment identifier as the succeeding identifier.

26. The method as claimed in claim 25, wherein the fragment identifier is at least one of a name, a timestamp and a universally unique identifier.

27. The method as claimed in claim 26, wherein said assigning issues identifiers in a sequence.

28. The method as claimed in claim 27, wherein the fragments have equal length.

29. The method as claimed in claim 28, wherein the fragments are encoded using at least one of a single data rate and a single codec.

30. The method as claimed in claim 29, further comprising storing the metadata structure in the corresponding fragment.

31. A method for decoding multimedia data stored in a data aggregate that includes mutually independent fragments and identifiers for corresponding fragments stored in metadata of the corresponding fragments, the metadata for each fragment including at least one of a preceding identifier of an immediately chronologically previous fragment and a succeeding identifier of an immediately chronologically following fragment, comprising:
reading and processing at least one of the preceding identifier and the succeeding identifier in the metadata of multiple fragments to establish a chronological connection between the multiple fragments in the data aggregate.

32. The method as claimed in claim 31, wherein each of the fragments of the data aggregate can be decoded and executed independently of other fragments in the data aggregate.

33. A device for encoding multimedia data, comprising:
a programmed processor forming a data aggregate encompassing the multimedia data from fragments that are mutually independent and generating and assigning to each of the fragments a fragment identifier, unique in each case, identifying a corresponding fragment; and
a storage unit coupled to said programmed processor and storing, in a metadata structure assigned to the corresponding fragment, the fragment identifier and at least one of a preceding identifier of an immediately chronologically previous fragment and a succeeding identifier of an immediately chronologically following fragment.

34. The device as claimed in claim 33, wherein said storage unit further stores, in the metadata structure of each fragment, encoding parameters concerning how the multimedia data in the corresponding fragment is encoded.

35. The device as claimed in claim 34, wherein said storage unit further stores, in the metadata structure of each fragment, at least one link to a storage location for at least one of the immediately chronologically previous fragment and the immediately chronologically following fragment.

36. The device as claimed in claim 35, wherein said storage unit further stores, in the metadata structure for an initial fragment which has no chronologically previous fragment, the fragment identifier as the preceding identifier.

37. The device as claimed in claim 36, wherein said storage unit further stores, in the metadata structure for a final fragment which has no chronologically succeeding fragment, the fragment identifier as the succeeding identifier.

38. A device for decoding multimedia data stored in a data aggregate that includes mutually independent fragments and identifiers for corresponding fragments stored in metadata of the corresponding fragments, the metadata for each fragment including at least one of a preceding identifier of an immediately chronologically previous fragment and a succeeding identifier of an immediately chronologically following fragment, comprising:
a programmed processor reading and processing at least one of the preceding identifier and the succeeding identifier in the metadata of multiple fragments to establish a chronological connection between the multiple fragments in the data aggregate.
